(19) United States
(12) Patent Application Publication
(10) Pub. No.: US 2022/0134211 A1
(43) Pub. Date: May 5, 2022

(54) METHOD AND SYSTEM FOR OPTIMIZING COLLECTION OF DATA TO DETECT AN OCCURANCE IN A LIVE EVENT

(71) Applicant: Spektacom Technologies Private Limited, Bangalore (IN)

(72) Inventors: Anil Kumble, Bangalore (IN); Harsha Chaturvedi, Bangalore (IN)

(21) Appl. No.: 17/431,011

(22) PCT Filed: Feb. 13, 2020
(86) PCT No.: PCT/IB2020/051173

§ 371 Date: Aug. 13, 2021

(30) Foreign Application Priority Data
Feb. 13, 2019 (IN) 201941005696

(51) Int. Cl. A63B 71/06; H04W 4/38; G06N 20/00

(52) U.S. Cl. CPC A63B 71/0669; A63B 2220/806; G06N 20/00; H04W 4/38

(57) ABSTRACT

The invention provides methods and system for providing optimized collection of data to detect an occurrence in a live event. A request is transmitted by a server, based on the machine learning, to activate at least one edge device located in a live event. Upon receipt of the request from the server, the at least one edge device captures at least one data of the live event. The data is captured by the at least one edge device using at least one sensor. The captured data is then transmitted by the one edge device to at least one node unit or directly to a server. The node unit may transmit the captured data or a processed data to the server. Thereafter, the server processes the data received by at least one of edge device or the node unit to detect an occurrence in the live event.

### FIELD OF THE INVENTION

The present invention generally relates to the field of collection of data, and more particularly, to a method and system for optimizing collection of data in a live event.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

During a live event, it is of utmost importance to capture all data as and when it occurs. The sensitivity of the data is based on the fact that any particular data may be relevant for determining an impact and cannot be repeated for capture. For example, if a shot in a badminton game is missed, it cannot be replayed for capturing again. Further, the data of the badminton shot may be extremely crucial to determine if the player won or lost the match. It is well known that such capturing of all relevant data and statistics of a live event, such as a sports match, is an important aspect of the business, analysis and appreciation of a live event. For instance, it is of crucial importance to determine who crossed the finishing line first to determine the winner of an Olympic marathon. Further, events on the sports field transpire in micro-seconds, such as the hit of a bat in cricket, the moment that the ball leaves a bowler's hand, the contact of two players in Kabaddi, speed of a bicycle at the time of crossing the finish line, and the like. This data happening in real-time for a very short period of time is desirable and must be captured to analyze its impact on the event.

Further, data of a live event such as a sports match may be recorded to be studied and analyzed further for comparison of performances of teams and individual players, studying of the sport technique, teaching to students etc. Moreover, teams, coaches, scouts, agents, and fans may also wish to review the sports game later to analyze the player's performance and ability.

In a live event, whether it be a sports game or any other event, today's telecast depends on the event itself as it unfolds. While the current technologies involve deploying many sensor devices such as cameras, microphones, bands, and other such devices on the field, to collect data of live event, the technology may fail to collectively give any intelligent information. These sensor devices are often not reliable as they are not designed to provide accurate and reliable analysis of the information of the live event and may often fail due to battery shortage. Further, the sensor devices may also often fail to capture a particular data. Furthermore, these devices often require the user to manually turn them on and off. These devices are also often disconnected and work as separate independent units. It has also been noted that these sensor devices may not operate at very high sampling rates. Even though the devices with high sampling rates may be used, the power of these devices may drain quickly due to high power consumption and the device may die before the entire event ends.

Therefore, in view of these and other existing limitations, there arises an imperative need to provide a solution to overcome the limitations of prior existing solutions and to provide a more reliable, long lasting and efficient mechanism of optimizing collection of data to detect an occurrence in a live event. There is also an imperative need to provide a mechanism to enable the collection of data by devices that do not require high consumption power and can operate for the entire duration of the live event.

### SUMMARY

This section is provided to introduce certain objects and aspects of the present disclosure in a simplified form that are further described below in the detailed description. This summary is not intended to identify the key features or the scope of the claimed subject matter. In order to overcome at least a few problems associated with the known solutions as provided in the previous section, an object of the present disclosure is to provide a method and system to optimize collection of data to detect an occurrence in a live event.

It is another object of the present disclosure is to provide a reliable and synergistic network of device configured at the location of a live event. It is another object of the present disclosure is to provide a mechanism for long-lasting power for devices to capture data of a live event. It is yet another objective of the system and method to enable collection of data by edge devices that need not require high power consumption and can operate for the entire duration of the live event. It is yet another objective of the system and method to provide a synergistic network of edge devices that are interconnected with each other to provide accurate and reliable information of the live event. It is yet another objective of the system and method to provide a synergistic network of edge devices that capable of providing information for processing and determining an occurrence in a live event. It is another objective of the system and method to configure a network of edge devices and a server wherein the edge devices are selectively interconnected and interoperable to each other in said network and the network is configured to work as a single unit.

In order to achieve the afore-mentioned objectives, the present disclosure provides a method for optimizing collection of data to detect an occurrence in a live event. The method commences when a server transmits a request to activate at least one edge device configured in a network at the live event. The invention encompasses that the at least one edge device is configured in a synergistic and interconnected manner in the live event. The request is transmitted to the at least one edge device based on the machine learning by the server. The invention further encompasses that the activity of the said at least one edge device is selectively controlled by server device to optimize collection of data Upon receipt of the request from the server, the at least one edge device captures at least one data of the live event. The data is captured by the at least one edge device using at least one sensor. In an embodiment, the data captured by the sensor in the at least one edge device is stored in a memory unit. The captured data is then transmitted by at least one edge device to at least one of the server and a node unit for processing. The node unit then transmits at least one of the captured data and the processed data to the server. Thereafter, the server processes the at least one data received by at least one of edge device or the node unit to detect an occurrence in the live event.

Another aspect of the present disclosure relates to a system for optimizing collection of data to detect an occurrence in a live event, comprising at least one edge device a node unit and a server. The at least one edge device is configured to capture at least one data of the live event in response to a request is received from a server. The at least one edge device are located in a configuration in a network at a live event and are connected to each other via a wireless connection. The invention encompasses that the at least one edge device is configured in a synergistic and interconnected manner in the live event. The invention further encompasses that said at least one edge device is configured to be selectively interconnected and interoperable to another at least one edge device in the network, said network being configured to work as a single unit. The at least one edge device comprises of at least one sensor, a transmitter, a receiver and a memory unit. The server is configured to transmit a request to activate at least one edge device wherein, the server is configured to automatically activate at least one edge device based on machine learning. The server is configured to process the at least one data received from at least one of edge device or at least one node unit to detect an occurrence in the live event. The at least one node unit is configured to receive the at least one data of the live event from the at least one edge device. The at least one node unit is also configured to process the at least one data of the live event received from the at least one edge device to detect a score in the live event. The at least node unit is also configured to transmit the at least one data of the live event received from the at least one edge device or the processed data the server to detect an occurrence in the live event.

### BRIEF DESCRIPTION OF THE DRAWINGS

The accompanying drawings, which are incorporated herein, and constitute a part of this disclosure, illustrate exemplary embodiments of the disclosed methods and systems in which like reference numerals refer to the same parts throughout the different drawings.

Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components.

FIG. 1 illustrates an architecture of a system [100] for optimizing collection of data to detect an occurrence in a live event, in accordance with exemplary embodiments of the present disclosure.

FIG. 2 illustrates an exemplary architecture [200] of an edge device [102] for optimizing collection of data to detect an occurrence in a live event, in accordance with exemplary embodiments of the present disclosure.

FIG. 3 illustrates an exemplary method flow diagram [200] depicting a method of optimizing collection of data to detect an occurrence in a live event, in accordance with exemplary embodiments of the present disclosure.

### DETAILED DESCRIPTION

In the following description, for the purposes of explanation, various specific details are set forth in order to provide a thorough understanding of embodiments of the present invention. It will be apparent, however, that embodiments of the present invention may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The present disclosure discloses a method and system for providing optimized collection of data to detect an occurrence in a live event. The invention commences when a server transmits a request to activate at least one edge device located in a live event. As used herein in this disclosure, a “live event” may be a cricket match, a music concert, a marathon, a football match, a kabaddi match, a gymnastic show, a play, a stage show, a social or cultural performance or any other such event, including sports matches/events, where real-time data must be captured for analysis. The invention encompasses that the at least one edge device is configured in a network at the live event, the configuration of at least one edge device within the network being based on the live event. The invention encompasses that the at least one edge device is configured in a synergistic and interconnected manner in the live event. The invention further encompasses that said at least one edge device is configured to be selectively interconnected and interoperable to another at least one edge device in the network, said network being configured to work as a single unit. The request is transmitted to the at least one edge device based on the machine learning by the server. Upon receipt of the request from the server, the at least one edge device captures at least one data of the live event. The data is captured by the at least one edge device using at least one sensor. In an embodiment, the data captured by the sensor in the at least one edge device is stored in a memory unit. The captured data is then transmitted by at least one edge device to at least one of the server and a node unit. In an embodiment, the at least one captured data is transmitted to the node unit for processing. The node unit then transmits at least one of the data captured by the edge device or the processed data to the server. Thereafter, the server processes the at least one data received by at least one of edge device or the node unit to detect an occurrence in the live event.

As used herein, the “edge device” refers to any electrical, electronic, electromechanical and computing device which is configured to capture data at a live event. The edge device may include, but not limited to, a camera, a sensor, a voice recorder, a bat with sensing electronics, and a mobile phone and any such device obvious to a person skilled in the art.

As used herein, a “server” or “node unit” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “connect”, “configure”, “couple” and its cognate terms, such as “connects”, “connected”, “configured” and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

The invention is further explained in detail below with reference now to the diagrams.

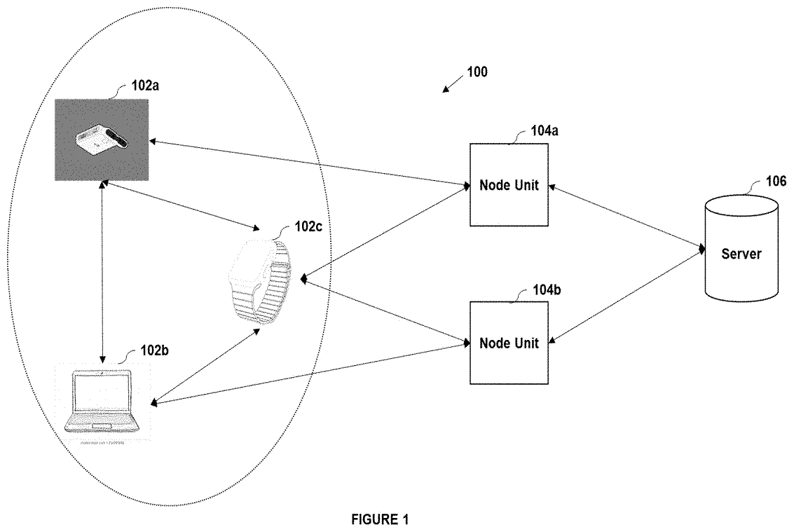

Referring to FIG. 1, an exemplary architecture of a system [100] for providing optimized collection of data to detect an occurrence in a live event, is disclosed in accordance with exemplary embodiments of the present invention. As shown in FIG. 1, the system [100] comprises of at least one edge device [102a], [102b], [102c], at least one node unit [104a], [104b] and a server [106] wherein all the components are assumed to be connected to each other unless otherwise indicated below. The disclosure encompasses that the at least one edge device [102a], [102b], [102c] may be collectively referred to as edge device and at least one node unit [104a], [104b] may be collectively referred to as node unit [104].

In a preferred embodiment, the invention encompasses that all the components of the system [100] may be connected to the other components via a network. As used herein, the network may be a wired or wireless network. For example, the at least one edge device [102] may be connected to the server [106] via a wireless network. In an embodiment, all the components of the system [100] may be connected to the other components using blockchain coding, encryption techniques or any other security measures.

Further, although only three edge device [102a], [102b] and [102c] are shown in the figure, it will be appreciated by those skilled in the art that the invention encompasses multiple such devices as may be necessary to implement the invention. Moreover, although only two node unit [104] and one server [106] are shown in the present disclosure, however, it will be appreciated by those skilled in the art that the invention encompasses multiple such units as may be necessary to implement the invention.

The edge device [102] of the present invention is configured to capture at least one data of a live event. As used herein, “data” may be any data, information, statistic related to the live event such as the acceleration/speed of a person or a equipment, the distance covered by a person or a device, the volume of a sound, a measurement of any vibration, the angle of any equipment or any other data that may be used to determine any characteristic or occurrence of the live event.

The invention encompasses that the edge device [102] are configured to be selectively controlled by the server [106]. The invention encompasses that the activity of the said at least one edge device [102] is selectively controlled to optimize collection of data by said at least one edge device [102]. As used herein in this disclosure, the “activity” refers to the operation and/or functional features of the said edge device [102] including, but not limited to, switching on of the said edge device [102], transmitting of data by the edge device [102], capturing of data by the edge device [102], stopping the capturing of data by the edge device [102] and switching off of the edge device [102]. For example, the edge device [102] may be turned on only when a signal to turn on is received from the server [106]. In another example, the edge device [102] may only transmit the captured data when a signal to transmit data is received from the server [106].

The invention further encompasses that the edge device [102] are configured to receive a request from the server [106]. In a preferred embodiment, the invention encompasses that the edge device [102] is configured to capture at least one data of the live event in response to the received request. As used herein, a request may be any signal or message received from at least one of the node unit [104] and server [106] to activate the edge device [102] and capture at least one data of the live event. In a preferred embodiment, the edge device [102] are also configured to receive a stop command from the server [106]. The invention encompasses that the edge device [102] is configured to terminate the capture of at least one data of the live event in response to the received stop command. As used herein, a stop command may be any signal or message received from the server [106] to deactivate the edge device [102] and stop the capturing at least one data of the live event. In an embodiment, the edge device [102] may be configured to be switched off the capture of at least one data of the live event in response to the received stop command.

The invention encompasses that the edge device [102] are located in a configured in a network at a live event. As used herein, “configured in a network” means a predetermined location or pattern in which the edge device [102] are fixed, attached or located in the live event and the said edge device [102] are connected to each other and one or more components such as the server [106] and one or more node units [104]. The invention encompasses that the at least one edge device is configured in a synergistic and interconnected manner in the configuration at the live event. The invention encompasses that the at least one edge device [102] are connected to each other to form a network. In a preferred embodiment, the at least one edge device [102] are connected to each other in a particular configuration to form a network. For example, the at least one edge device [102] may be connected to each other in a star configuration to form a network of devices at the live event, such as a cricket match, wherein each device is connected to the other device. In another example, the at least one edge device [102] may be connected to each other in a polygon configuration to form a network of devices at the live event such as a music concert, wherein each device is connected to another device. The invention encompasses that the at least one edge device [102] are connected to each other via a wireless or wired connection. As used herein, a connection may be any wireless or wired connection known for communicating between devices to a person skilled in the art such as a Bluetooth connection, infrared connection. In a preferred embodiment, the at least one edge device [102] may be connected to each other in a star configuration to form a network of devices at the live event, such as a cricket match, wherein each device is connected to the other device using a Bluetooth or infrared connection.

Then invention further encompasses that the configuration of the edge device [102] is based on the live event. For example, the edge device [102] may be in a particular configuration for a one-day internal (ODI) cricket match. In another example, the edge device [102] may be in a particular configuration for a 5-day test cricket match, wherein the configuration is a different configuration. In another example, the edge device [102] may be in a particular configuration for a kabaddi match. In yet another example, the edge device [102] may be in a particular configuration for a music concert, wherein the configuration is a different configuration.

The invention furthermore encompasses that said at least one edge device [102] is configured to be selectively interconnected and interoperable to another at least one edge device [102] in the network. As used herein, “selectively interconnected” shall mean interconnection between the edge devices [102], node unit [104] and server [106] based on a defined manner, wherein the edge devices are capable of transmitting and sharing data amongst each other. As used herein, “interoperable” shall mean that the edge devices [102], the node unit [104] and the server [106] are operable or working based on interconnection between each other, wherein the devices are capable of transmitting and sharing data between each other. Further, the network may be configured to work as a single unit. As used herein, “single unit” shall mean that the edge devices [102], node unit [104] and server [106] are interconnected, interoperable and working as if all the edge devices [102], node unit [104] and server [106] form a single system/unit based on transmitting and sharing data amongst each other.

The edge device [102] is further configured to transmit the at least one data to at least one of the node unit [104] and server [106]. In a preferred embodiment, the invention encompasses that at least one data of the live event is transmitted to at least one of the node unit [104] and server [106] dynamically. For example, the at least one data of the live event may be transmitted from the at least one edge device [102] to at least one of the node unit [104] and server [106] when a data is captured by the edge device [102]. For example, the edge device [102] may instantaneously transmit the data to the to at least one of the node unit [104] and server [106] when the edge device [102] captures vibrations resultant from a ball hitting the stump box in a cricket match. In another example, the edge device [102] may instantaneously transmit the data to the to at least one of the node unit [104] and server [106] when the edge device [102] captures acceleration resultant from a player running in a cricket match. In another embodiment, the invention encompasses that at least one data of the live event is transmitted to at least one of the node unit [104] and server [106] periodically. For example, the at least one data of the live event may be transmitted from the at least one edge device [102] to at least one of the node unit [104] and server [106] after every 10 minutes.

The node unit [104] is configured to receive the at least one captured data of the live event from the at least one edge device [102]. As used herein, the “captured data” is the data of the live event captured/collected/sensed by the at least one edge device [102]. For example, the node unit [104] may receive from a first edge device [102a] an acceleration data of a player and receive from a second edge device [102b] a vibration data from a ball hitting a bat. In a preferred embodiment, the invention encompasses that at least one data of the live event is received by the node unit [104] from the at least one edge device [102] dynamically. For example, the at least one data of the live event may be received from the at least one edge device [102] when a data is captured by the edge device [102]. In another embodiment, the invention encompasses that at least one data of the live event is received by the node unit [104] periodically. For example, the at least one data of the live event may be received by the node unit [104] from at least one of edge device [102] after every 10 minutes.

The node unit [104] is further configured to process the at least one data of the live event received from the at least one edge device [102]. The invention encompasses that the node unit [104] is configured to process the received data of the live event to detect an impact in the live event. As used herein in this disclosure, a “score” is any event or happening that has occurred in the live event such as analyzing if the ball has crossed the crease line, the ball has hit the bat, a player has caught the ball, the ball has entered a goal, the players ran, the ball has hit the wicket, the ball has hit by the player's leg, the volume of the music or any such event or happening that is relevant for the live event. For example, the node unit [104] may process the acceleration data received from a first edge device [102a] and a vibration data from a ball hitting a bat from a second edge device [102b] to determine if the ball has been hit by the batsman of the cricket match.

The node unit [104] is further configured to transmit the at least one data of the live event received from the at least one edge device [102] to the server [106]. In a preferred embodiment, the node unit [104] is configured to transmit the processed data of the live event to the server [106]. For example, the node unit [104] may transmit the processed data determined if the ball has hit the leg of the batsman of the cricket match to the server [106]. In another embodiment, the node unit [104] is configured to transmit the captured data of at least one edge device [102] to the server [106]. For example, the node unit [104] may directly transmit the acceleration data received from a first edge device [102a] to the server.

The server [106], connected to the at least one edge device [102] and node unit [104], is configured to selectively control at least one edge device [102]. The invention encompasses that the server [106] is configured to selectively control the activity of the said at least one edge device [102] to optimize collection of data by said at least one edge device [102]. For example, the server [106] may be configured to transmit a signal to turn on the edge device [102]. In another example, the server [106] may be configured to transmit a signal to transmit the data captured by the edge device [102].

The invention further encompasses that the server [106] may be configured to transmit a request to activate at least one edge device [102]. The invention encompasses that the request is transmitted to at least one edge device [102] to capture at least one data of the live event in response to the request. As used herein, a request may be any signal or message to activate the edge device [102] and capture at least one data of the live event.

In a preferred embodiment, the server [106] is also configured to transmit a stop command to the at least one edge device [102]. As used herein, a stop command may be any signal or message received from the server [106] to deactivate the edge device [102] and stop the capturing at least one data of the live event.

The invention further encompasses that the server [106] is also configured to transmit a request/signal to the edge device [102] based on machine learning techniques to selectively control the activity of the edge device [102]. In a preferred embodiment, the server [106] is also configured to transmit a signal to stop the capturing of data to the at least one edge device [102] based on machine learning techniques. As used herein, machine learning techniques includes techniques of artificial intelligence and neural network as known to a person skilled in the art. For example, the server [106] may determine when a player is about to throw the ball in a cricket match based on machine learning techniques. In case the machine learning technique determines that the player is about to run to throw the ball, the server [106] may send a request to at least one of the edge device [102] to activate and capture the data relating to the speed and acceleration of the player and the ball and the vibration data when the ball hits the bat. In another example, the server [106] may determine when the game has ended or if there is a break, based on machine learning techniques. In case the machine learning technique determines that the game has ended or if there is a break, the server [106] may send a stop command to at least one of the edge device [102] to deactivate and stop the capture of data to at least one edge device [102].

The server [106] is further configured to receive at least one of the data from at least one edge device [102] and the processed data from the node unit [104]. For example, the server [106] may receive from a first edge device [102a] an acceleration data of a ball and receive from a second edge device [102b] a vibration data from a ball hitting a bat. In a preferred embodiment, the server [106] is also configured to receive the processed data from the node unit [104]. The server [106] is further configured to process the at least one data received by the edge device [102] to detect an occurrence in the live event. As used herein, an “occurrence” is a determination based on the captured data in the live event indicating a characteristic relevant for the live event such as if the ball has scored a sixer when the ball crosses the crease, a player is out because a player has caught the ball, a run is scored as the ball has entered a goal, the number of runs secured by the players, if a wicket has been taken, if a goal has been secured when the ball has hit by the player's leg, the volume of the music or any such analysis of an event that is relevance for the live event and/or audience. For example, the server [106] may process the acceleration data received from a first edge device [102a] and a processed data of a ball hitting a bat from a node unit [104a] to determine if the ball has been caught by a bailer of the cricket match and the batsman is to be declared out.

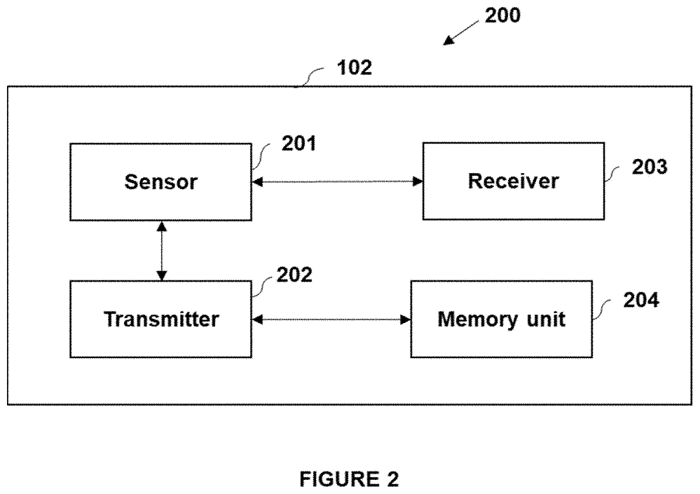

Now, referring to FIG. 2, depicting a system [200] of the at least one edge device [102] comprising of at least one sensor [201], transmitter [202], receiver [203] and a memory unit [204], is disclosed in accordance with exemplary embodiments of the present invention. It will be appreciated by a person skilled in the art that although only four components are detailed herein in this disclosure, the edge device [102] may incorporate may other components including, but not limited to, processing units.

In a preferred embodiment, the invention encompasses that all the components of the edge device [102] may be connected to each other. Further, although only one component of the edge device [102] are shown in the figure, it will be appreciated by those skilled in the art that the invention encompasses multiple such components as may be necessary to implement the invention. Moreover, although only one edge device [102] are shown in the present disclosure, however, it will be appreciated by those skilled in the art that the invention encompasses multiple such units as may be necessary to implement the invention.

The sensor [201] is configured to capture at least one data of a live event. The sensor includes, but is not limited to a gyroscope, an accelerator, a piezo electric sensor, an oscilloscope, a camera, MEMS sensors, audio recorder and/or radar reflectors. For example, the sensor [201] may be a piezo electric sensor to capture vibration data. In another example, the sensor [201] may be a camera to capture an image of the live event.

The sensor [201] is also configured to receive a signal/command from the server [106] vis the receiver [203] to operate. For example, the sensor [201] may be configured to only start/activate in response to a signal received from the server [106] via the receiver [203]. In another example, the sensor [201] may be configured to only capture the data for the time period received from the server [106] via the receiver [203].

The transmitter [202] is configured to receive the at least one captured by the sensor [201]. The transmitter [202] is also configured to transmit the at least one data captured by the sensor [201] to at least one of the node unit [104] and server [106]. In a preferred embodiment, the invention encompasses that at least one data of the live event captured by the sensor [201] is transmitted to at least one of the node unit [104] and server [106] dynamically. In another embodiment, at least one data of the live event captured by the sensor [201] is transmitted to at least one of the node unit [104] and server [106] periodically.

The invention encompasses that the transmitter [202] is configured to transmit the at least one data captured by the sensor [201] to at least one of the node unit [104] and server [106] using a wireless or wired connection. For example, the transmitter [202] is configured to transmit the at least one data captured by the sensor [201] to at least one of the node unit [104] and server [106] using a 4G/LTE connection.

The receiver [203] is configured to receive a request from the server [106]. In a preferred embodiment, the invention encompasses that the receiver [203] is configured to send a message to the sensor [201] to capture at least one data of the live event in response to the received request. The invention encompasses that the receiver [203] is configured to receive a command/signal from the server [106] to selectively control the activity of the edge device [102] to optimize collection of data.

In a preferred embodiment, the receiver [203] is also configured to receive a stop command from the server [106]. The invention encompasses that the receiver [203] is configured to transmit the request to the sensor [201] to terminate the capture of at least one data of the live event in response to the received stop command.

The invention encompasses that the receiver [203] is configured to receive the request or stop command from the server [106] using a wireless or wired connection. For example, the receiver [203] is configured to receive a request from the server [106] using a 4G/LTE connection. Similarly, the receiver [203] is configured to receive the stop command from the server [106] using a wireless or wired connection. For example, the receiver [203] is configured to receive the stop command from at least one of the node unit [104] and server [106] using a Bluetooth connection.

The memory unit [204] is configured to store at least one data captured of a live event. As used herein, the memory unit [204] may include, but is not limited to, a volatile memory, non-volatile memory, a remote storage, a cloud storage, high-speed random-access memory and/or non-volatile memory, such as one or more magnetic disk storage devices, one or more optical storage devices, and/or flash memory (e.g., NAND, NOR) or a combination thereof. The memory unit [204] is further configured to transmit the at least one data captured of a live event to the transmitter [202] to transmit it to at least one of the server [106] and node unit [104].

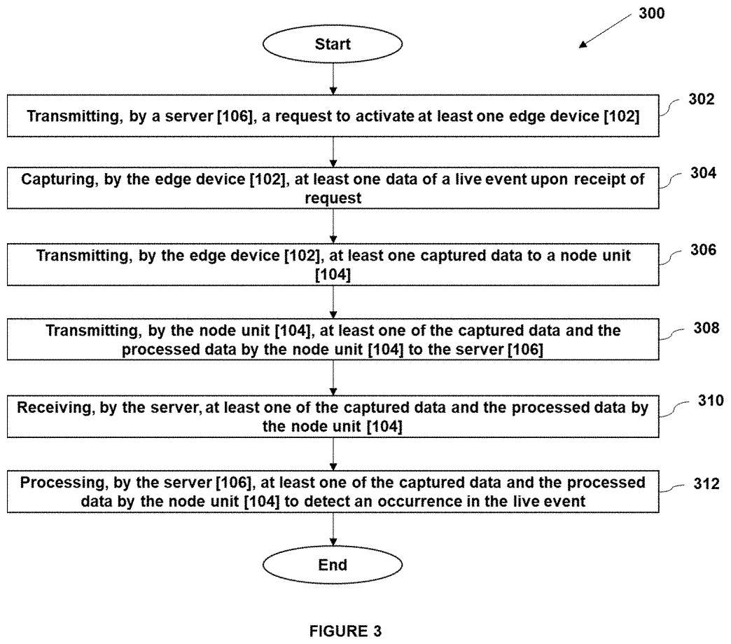

Now, referring to FIG. 3, an exemplary method flow diagram [300] depicting a method of providing optimized collection of data to detect an occurrence in a live event, is disclosed in accordance with exemplary embodiments of the present invention. The method [300] commences at step 200. At step 302, a request is transmitted to activate at least one edge device [102] by a server [106]. The invention encompasses that the request from the server [106] may be received by the edge device [102]. As used herein, a request may be any signal or message received from at least one of the node unit [104] and server [106] to activate the edge device [102] and capture at least one data of the live event.

The invention encompasses that the server [106] can selectively control the at least one or more edge device [102]. The invention encompasses that the activity of the said at least one edge device [102] is selectively controlled to optimize collection of data by said at least one edge device [102]. For example, the edge device [102] may be turned on only when a signal to turn on is received from the server [106]. In another example, the edge device [102] may only transmit the captured data when a signal to transmit the data is received from the server [106]. The invention further encompasses that the server [106] selectively controls the activity of the edge device [102] based on machine learning techniques. In a preferred embodiment, the server [106] may transmit a signal to start the capturing of data to the at least one edge device [102] based on machine learning techniques. For example, the server [106] may determine when a player is about to hit the ball in a cricket match based on machine learning techniques. In case the machine learning technique determines that the player is about to hit the ball, the server [106] may send a request to at least one of the edge device [102] to activate and capture the data relating to the speed and acceleration of the player and the ball and the vibration data when the foot of the player hits the ball. In another example, the server [106] may determine when there is half-time in the match based on machine learning techniques. In case the machine learning technique determines that the game is suspended, the server [106] may send a stop command to at least one of the edge device [102] to deactivate and stop the capture of data to at least one edge device [102]. In yet another example, the server [106] may determine the time period for which the data must be captured based on machine learning techniques. In case the machine learning technique determines a time period of 3 minutes, the server [106] may send a signal/command to at least one of the edge device [102] to capture data for only 3 minutes.

In a preferred embodiment, a stop command may also be received by the edge device [102] from the server [106]. The invention encompasses that the stop commands terminate the capture of at least one data of the live event by the edge command [102] in response to the received stop command. As used herein, a stop command may be any signal or message received from the server [106] to deactivate the edge device [102] and stop the capturing at least one data of the live event.

The invention encompasses that said at least one edge device [102] is configured to be selectively interconnected and interoperable to another at least one edge device [102] in the network. Further, the network may be configured to work as a single unit.

At step 304, at least one data of a live event is captured by at least one edge device [102]. The invention encompasses that the at least one data is captured in response to a request received from the server [106]. As used herein, “data” may be any data, information, statistic related to the live event such as the speed of a person, the distance of a device, the speed of a device, the volume of the sound, the measurement of any vibrations or any other data that may be used to determine any characteristic or occurrence of the live event.

At step 306, the at least one captured data is transmitted by at least one edge device [102] to the node unit [104]. In a preferred embodiment, the invention encompasses that at least one data of the live event captured by the edge device [102] is transmitted to at least one of the node unit [104] and server [106] dynamically. In another embodiment, at least one data of the live event captured by the sensor [201] is transmitted to at least one of the node unit [104] and server [106] periodically. For example, the at least one data of the live event may be transmitted from the at least one edge device [102] to at least one of the node unit [104] and server [106] when a data is captured by the edge device [102]. For example, the edge device [102] may instantaneously transmit the data to the to at least one of the node unit [104] and server [106] when the edge device [102] captures acceleration resultant from a bailer running to throw a ball in a cricket match. In another example, the at least one data of the live event may be transmitted from the at least one edge device [102] to at least one of the node unit [104] and server [106] after every 3 minutes.

The invention encompasses that the at least one captured data from the at least one edge device [102] is processed by the node unit [104]. The invention encompasses that the received data of the live event is processed by the node unit [104] to detect a score in the live event. For example, the node unit [104] may process the acceleration data received from a first edge device [102a] and a vibration data from a ball hitting a bat from a second edge device [102b] to determine if the ball has been hit by the batsman of the cricket match.

At step 308, at least one of the captured data by the edge device [102] and the processed data by the node unit [104] is transmitted to the server [106]. For example, the node unit [104] may transmit the processed data determined if the ball has hit the leg of the batsman of the cricket match to the server [106]. In another example, the node unit [104] may transmit the captured acceleration data by at least one edge device [102] of cricket match to the server [106].

At step 310, the at least one of the captured data and the processed data by the node unit [104] is received by the server [106].

At step 312, the server [106] processes the at least one of the captured data and the processed data by the node unit [104] to detect an occurrence in the live event. The invention encompasses processing the at least one of the captured data received by the edge device [102] and the processed data by the node unit [104] to detect an occurrence in the live event. For example, the server [106] may process the acceleration data received from a first edge device [102a] and a processed data of a ball hitting a bat from a node unit [104a] to determine if the ball has been caught by a bailer of the cricket match and the batsman is to be declared out.

Therefore, the present disclosure discloses a novel system for providing a network of devices to capture data of a live event. The system enables each edge device [102] to have long-lasting duration of battery life/power as the computation, analysis or processing of captured data by the edge device [102] is performed by at least one of the node unit [104] and the server [106]. The inventive system further enables collection of data by edge devices [102] that need not require high power consumption, are smaller in size and design, less complex and can operate for the entire duration of the live event. Further, the present invention optimizes the use and battery life of at least one edge device [102] by enabling the edge devices [102] to be controlled remotely by a server [106] using machine learning techniques. This enables the edge device [102] to be operating only for the duration of data capture and can be dynamically controlled, thereby saving power and battery life. The present invention provides a synergistic network of edge devices [102] where each device is interconnected to provide accurate and reliable information of the live event.

While considerable emphasis has been placed herein on the disclosed embodiments, it will be appreciated that many embodiments can be made and that many changes can be made to the embodiments without departing from the principles of the present invention. These and other changes in the embodiments of the present invention will be apparent to those skilled in the art, whereby it is to be understood that the foregoing descriptive matter to be implemented is illustrative and non-limiting.

1. A system for optimizing collection of data to detect an occurrence in a live event, the system comprising:
at least one edge device configured to capture at least one data of the live event, said at least one data being captured in response to a request received from a server;
the server being configured to process the at least one captured data by at least one of edge device to detect an occurrence in the live event;
wherein,
said at least one edge device is configured in a network connected to the server, the configuration of at least one edge device within the network being based on the live event,
said at least one edge device is configured to be selectively interconnected and interoperable to another at least one edge in said network, said network being configured to work as a single unit, and
said server is configured to selectively control the activity of the said at least one edge device to optimize collection of data.

2. The system as claimed in claim 1, further comprising at least one node unit configured to receive the at least one captured data of the live event from the at least one edge device.

3. The system as claimed in claim 2, wherein the at least node unit is further configured to process the at least one data of the live event received from the at least one edge device to detect a score in the live event.

4. The system as claimed in claim 3, wherein the at least node unit is further configured to transmit the detected score to the server.

5. The system as claimed in claim 1, wherein the at least one edge device are located in a configuration at a live event.

6. The system as claimed in claim 5, wherein the at least one edge device are connected to each other via a wireless connection.

7. The system as claimed in claim 1, wherein the at least one edge device comprises of at least one sensor, transmitter and receiver.

8. The system as claimed in claim 8, wherein the at least one edge device comprises of a memory unit to store the captured data.

9. The system as claimed in claim 8, wherein the at least sensor may be at least one of a gyroscope, an accelerator, a piezo electric sensor, an oscilloscope, a camera, MEMS sensors, audio recorder and/or radar reflectors.

10. The system as claimed in claim 1, wherein the server is further configured to transmit a stop command to at least one edge device using machine learning.

11. The system as claimed in claim 11, wherein the at least edge device is further configured to stop the capturing of at least one data when a stop command is dynamically received from the server.

12. A method for optimizing collection of data to detect an occurrence in a live event, the method comprising:
transmitting, by a server, a request to activate at least one edge device, wherein said server is configured to selectively control the activity of the said at least one edge device to optimize collection of data and said at least one edge device is configured in a network connected to the server, the configuration of at least one edge device within the network being based on the live event; and
wherein said at least one edge device is configured to be selectively interconnected and interoperable to another at least one edge in said network, said network being configured to work as a single unit;
capturing, by at least one edge device, at least one data of a live event in response to a request received from the server; and
processing, by the server, the at least one captured data by at least one of edge device to detect an occurrence in the live event.

13. The method as claimed in claim 13, further comprising receiving, by at least one node unit, the at least one captured data of the live event from the at least one edge device.

14. The method as claimed in claim 14, further comprising processing, by the at least node unit, the at least one data of the live event received from the at least one edge device to detect a score in the live event.

15. The method as claimed in claim 13, further comprising transmitting, by the at least node unit, the detected score in the live event to the server.

16. The method as claimed in claim 13, further comprising transmitting, by the server, a stop command to at least one edge device based on machine learning.

17. The method as claimed in claim 17, further comprising stopping the capturing of at least one data, of at least edge device, when the stop command is dynamically received from the server.

18. The method as claimed in claim 13, further comprising storing the captured data in a memory unit by at least one edge device.
